(19) United States
(12) Patent Application Publication
(10) Pub. No.: US 2022/0074556 A1
(43) Pub. Date: Mar. 10, 2022

(54) LAMP WICK AND ELECTRONIC CANDLE

(71) Applicant: Guangzhou Jiaheng Crafts Co., Ltd., Guangzhou, Guangdong (CN)

(72) Inventor: Jiang Chang, Guangzhou, Guangdong (CN)

(21) Appl. No.: 17/283,110

(22) PCT Filed: Jul. 17, 2020
(86) PCT No.: PCT/CN2020/102824

§ 371 Date: Apr. 6, 2021

(30) Foreign Application Priority Data
Apr. 30, 2020 (CN) 202020717814.8

(51) Int. Cl. F21S 6/00; F21S 10/04

(52) U.S. Cl. CPC F21S 6/001; F21Y 2115/10; F21S 10/04

(57) ABSTRACT

Disclosed is a lamp wick and an electronic candle. The lamp wick includes a first body and a light-transmitting second body, the second body is hollow, and mounted on the first body, and two light-emitting elements are disposed in a cavity formed by the first body and the second body. The lamp wick is designed to be hollow with light-emitting elements disposed inside.

### CROSS-REFERENCE TO RELATED APPLICATIONS

This application is a national stage filing under 35 U.S.C. § 371 of International Application No. PCT/CN2020/102824, filed Jul. 17, 2020, which claims priority to Chinese Patent Application No. 202020717814.8, filed Apr. 30, 2020, wherein the entire contents of the foregoing applications are hereby incorporated by reference herein.

### TECHNICAL FIELD

The present disclosure relates to the technical field of decorative lighting, and in particular, to a lamp wick and an electronic candle.

### BACKGROUND

Electronic candles, also referred to as imitation candles, are widely applied to many scenarios to replace conventional candles as the simulated electronic candles are safe and environmentally friendly. Common electronic candles create a candle flame effect by enabling a light source to illuminate a swingable flame sheet that is mounted on a swing bar. However, currently, common electronic candles create a poor candle flame effect.

### SUMMARY

To address the foregoing technical problems and improve a created candlelight effect, the present disclosure provides a lamp wick and an electronic candle. The following technical solutions are used:

A lamp wick provided in the present disclosure includes a first body and a light-transmitting second body, where the second body is hollow, the second body is mounted on the first body, and two light-emitting elements are disposed in a cavity formed by the first body and the second body.

Further, the two light-emitting elements have different lighting colors.

Further, the two light-emitting elements are disposed in upper and lower positions, respectively.

Further, the second body is in a candle flame shape.

Further, a first mounting portion used to mount the second body is formed on the first body, and the second body is sleeved on the first mounting portion.

Further, a limiting ridge is formed on the first mounting portion, the limiting ridge is formed along a direction in which the second body is sleeved, and a limiting groove corresponding to the limiting ridge is formed on an inner wall of the second body.

An electronic candle provided in the present disclosure includes a lamp wick.

Further, the electronic candle further includes a candle body and a powering base, where a battery, a control panel, and an on/off button are mounted on the powering base, the lamp wick is mounted on the top of the candle body, and the lamp wick is connected to the control panel by using a conducting wire.

Further, a third mounting base is disposed on the top of the candle body, a third through-hole for mounting the third mounting base is formed on the top of the candle body, the third mounting base has a third stop portion for abutting against the lower end of the third through-hole, and the conducting wire is connected to the lamp wick by passing through the third mounting base.

Further, a portion of the conducting wire that passes through the third mounting base is fastened by using glue.

Beneficial effects: The lamp wick is designed to be hollow with light-emitting elements disposed inside. Such a design makes the lamp wick emit light stably and the candlelight effect is stable. The two light-emitting elements are designed to have different lighting colors, making a created candlelight effect better. The present disclosure can be widely applied to the technical field of decorative lighting.

### BRIEF DESCRIPTION OF THE DRAWINGS

FIG. 1 is a structural diagram of a lamp wick;

FIG. 2 is a cross-sectional view of a lamp wick;

FIG. 3 is a structural diagram of a second body;

FIG. 4 is a structural diagram of a first body; and

FIG. 5 is a schematic structural diagram of an electronic candle.

### DETAILED DESCRIPTION

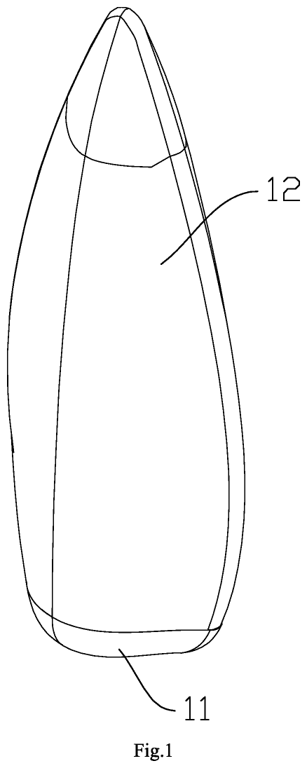

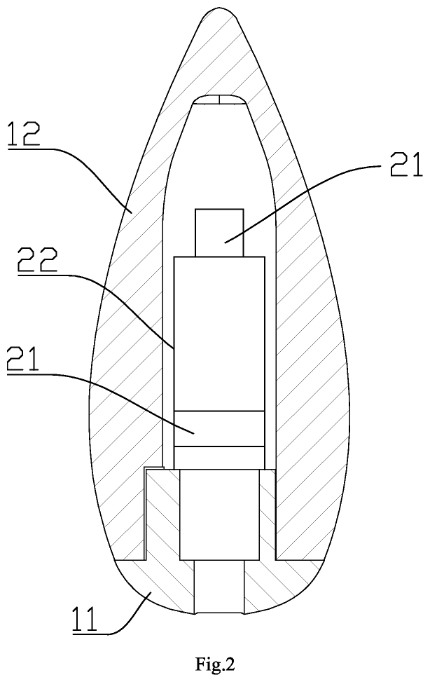

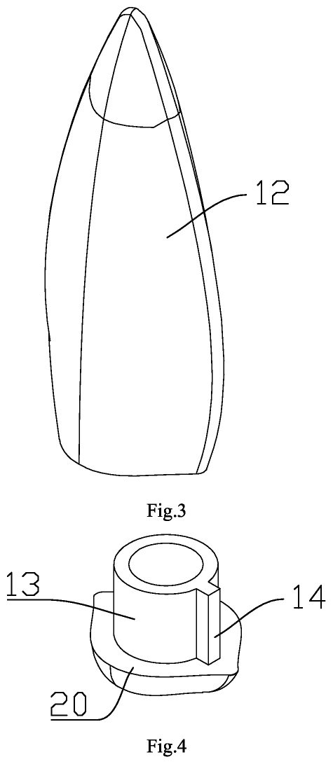

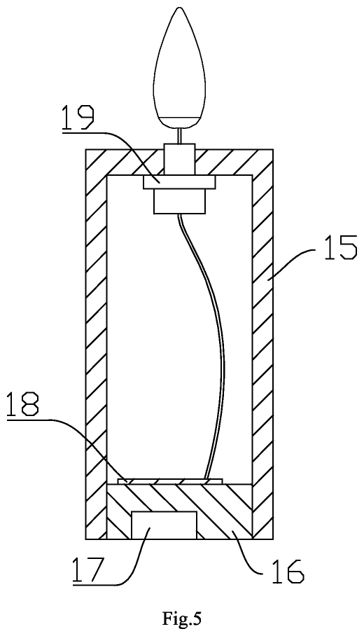

The following further describes the present disclosure with reference to FIG. 1 to FIG. 5.

The present disclosure relates to an electronic candle that includes a lamp wick. In some embodiments, the electronic candle further includes a candle body 15 and a powering base 16. The powering base 16 is located at the bottom of the candle body 15, and the lamp wick is mounted on the top of the candle body 15. A battery 17, a control panel 18, and an on/off button are mounted on the powering base 16. The lamp wick is connected to the control panel 18 by using a conducting wire. The on/off button is configured to light the lamp wick up.

In some embodiments, a third mounting base 19 is disposed on the top of the candle body 15. The third mounting base 19 is detachably mounted on the candle body 15. A third through-hole for mounting the third mounting base 19 is formed on the top of the candle body 15. The third mounting base 19 extends out from the upper end of the third through-hole. The third mounting base 19 has a third stop portion for abutting against the lower end of the third through-hole. The third mounting base 19 and an inner wall of the third through-hole are fastened to each other through transition fit.

The conducting wire is connected to the lamp wick by passing through the third mounting base 19. In some embodiments, a portion of the conducting wire that passes through the third mounting base 19 is fastened by using glue. A place coated with glue on the conducting wire is cured to maintain an upright state, so that the lamp wick keeps upright.

The present disclosure relates to a lamp wick. The lamp wick includes a first body 11 and a light-transmitting second body 12. The second body 12 is hollow. The second body 12 is mounted on the first body 11. Two light-emitting elements 21 are disposed in a cavity formed by the first body 11 and the second body 12. The two light-emitting elements 21 are fastened to the first body 11 by using a support 22. A through-hole for a conducting wire to pass through is formed at the bottom of the first body 11.

In some embodiments, the second body 12 is in a candle flame shape.

In some embodiments, the two light-emitting elements 21 have different lighting colors, and therefore the upper portion and the lower portion of the lamp wick emit different light. Further, the two light-emitting elements 21 are disposed in upper and lower positions, respectively. For example, yellow light is emitted above, and blue light is emitted at the bottom.

Compared with a conventional electronic candle on which a swingable flame sheet and a swing bar often get stuck, in this embodiment of the present disclosure, the lamp wick is designed to be hollow with the light-emitting elements disposed inside, and therefore a created candlelight effect is stable. Further, the two light-emitting elements 21 are designed to emit light of different colors, and therefore a created candlelight effect is better.

In some embodiments, a first mounting portion 13 used to mount the second body 12 is formed on the first body 11, and the second body 12 is sleeved on the first mounting portion 13.

In some embodiments, a limiting ridge 14 is formed on the first mounting portion 13, the limiting ridge 14 is formed along a direction in which the second body 12 is sleeved, and a limiting groove corresponding to the limiting ridge 14 is formed on an inner wall of the second body 12. Fit between the limiting ridge 14 and the limiting groove ensures that the first mounting portion 13 and a second mounting portion are correctly aligned.

In some embodiments, a support face 20 is formed in the first body 11, and the first mounting portion 13 is located on the support face 20. After the second body 12 is sleeved on the first mounting portion 13, the support face 20 abuts against the lower end of the second body 12.

In some embodiments, an alternative design may be that the first mounting portion 13 is formed in the second body 12.

In some embodiments, an alternative design may be that the limiting ridge 14 is formed on the inner wall of the second body 12, and the limiting groove is formed in the first mounting portion 13.

The foregoing describes the implementations of the present disclosure in detail with reference to the accompanying drawings. However, the present disclosure is not limited to the foregoing implementations. Within the scope of knowledge possessed by a person of ordinary skill in the art, various changes may further be made without departing from the purpose of the present disclosure.

1. A lamp wick, comprising a first body and a light-transmitting second body, wherein the second body is hollow, and mounted on the first body, and two light-emitting elements are disposed in a cavity formed by the first body and the second body.

2. The lamp wick of claim 1, wherein the two light-emitting elements have different lighting colors.

3. The lamp wick of claim 1, wherein the two light-emitting elements are disposed in upper and lower positions, respectively.

4. The lamp wick of claim 1, wherein the second body is in a candle flame shape.

5. The lamp wick of claim 1, wherein a first mounting portion used to mount the second body is formed on the first body, and the second body is sleeved on the first mounting portion.

6. The lamp wick of claim 5, wherein a limiting ridge is formed on the first mounting portion, the limiting ridge is formed along a direction in which the second body is sleeved, and a limiting groove corresponding to the limiting ridge is formed on an inner wall of the second body.

7. An electronic candle, comprising the lamp wick of claim 1.

8. The electronic candle of claim 7, further comprising a candle body and a powering base, wherein a battery, a control panel, and an on/off button are mounted on the powering base, the lamp wick is mounted on the top of the candle body, and the lamp wick is connected to the control panel by using a conducting wire.

9. The electronic candle of claim 8, wherein a third mounting base is disposed on the top of the candle body, a third through-hole for mounting the third mounting base is formed on the top of the candle body, the third mounting base has a third stop portion for abutting against the lower end of the third through-hole, and the conducting wire is connected to the lamp wick by passing through the third mounting base.

10. The electronic candle of claim 9, wherein a portion of the conducting wire that passes through the third mounting base is fastened by using glue.
